(19) United States
(12) Patent Application Publication
(10) Pub. No.: US 2021/0324807 A1
(43) Pub. Date: Oct. 21, 2021

(54) FLUID PUMP SYSTEM

(71) Applicant: AISAN KOGYO KABUSHIKI KAISHA, Obu-shi (JP)

(72) Inventor: Takahiro Sasaki, Tokai-shi (JP)

(21) Appl. No.: 17/230,044

(22) Filed: Apr. 14, 2021

(30) Foreign Application Priority Data
Apr. 16, 2020 (JP) 2020-073499

(51) Int. Cl. F02D 41/00; F02M 25/08

(52) U.S. Cl. CPC F02D 41/004; F02D 2200/0414; F02M 25/089; F02M 25/0836

(57) ABSTRACT

A fluid pump system having a fluid pump that includes a motor, a bearing supporting an output shaft of the motor, and an impeller attached to the output shaft; a detector configured to detect a temperature of the bearing; and a controller configured to control an output of the motor. The controller is configured to output power that is lower than a designated power supply to the motor when the temperature detected by the detector is lower than a predetermined temperature.

### TECHNICAL FIELD

This application claims priority to Japanese Patent Application No. 2020-073499 filed on Apr. 16, 2020, the contents of which are hereby incorporated by reference into the present application. The disclosure herein discloses art related to a fluid pump system.

### BACKGROUND

Japanese Patent Application Publication No. H5-340315 (hereinbelow termed Patent Literature 1) describes a technique of adsorbing evaporated fuel generated in a fuel tank by a canister and introducing the adsorbed evaporated fuel to an intake pipe connected to an engine as purge gas. Patent Literature 1 uses a fluid pump system to pump the purge gas to the intake pipe. The fluid pump system includes a fluid pump and a control device that controls operation of the fluid pump. The control device controls torque of the fluid pump in accordance with an amount of the purge gas introduced into the intake pipe. The fluid pump pumps the purge gas to the intake pipe by rotating its impeller using a motor. The impeller is fixed to an output shaft of the motor, and the output shaft is supported on a casing via a bearing.

### SUMMARY

As aforementioned, the output shaft of the motor is supported by the bearing in the fluid pump. Lubricant (grease) is used in the bearing for reducing friction between a roller (or balls) and races and/or friction between the roller (or balls) and the output shaft. The lubricant has a characteristic that its viscosity changes according to its temperature. When the fluid pump is operated in the state where the viscosity of the lubricant is high, a load on the motor increases, deterioration of the fluid pump progresses, and durability may thereby be decreased. Due to this, art for improving durability of a fluid pump is in demand. The disclosure herein provides art related to a fluid pump system that may improve durability of a fluid pump.

A first aspect disclosed herein may be a fluid pump system comprising: a fluid pump including a motor, a bearing supporting an output shaft of the motor, and an impeller attached to the output shaft; a detector configured to detect a temperature of the bearing; and a controller configured to control an output of the motor. In this fluid pump system, the controller may be configured to output power that is lower than a designated power supply to the motor when the temperature detected by the detector is lower than a predetermined temperature.

A second aspect disclosed herein may be the fluid pump system according to the first aspect, in which the fluid pump system may be used in an evaporated fuel processing device configured to supply evaporated fuel generated in a fuel tank to an intake pipe connected to an engine. Further, the evaporated fuel processing device may comprise: a canister configured to adsorb the evaporated fuel generated in the fuel tank; a purge pipe connecting the canister to the intake pipe; and a purge control valve configured to switch between a state where the canister communicates with the intake pipe and a state where the cannister is cut off from the intake pipe. In this fluid pump system, the fluid pump may be arranged upstream of the purge control valve and configured to pump purge gas from the canister to the intake pipe.

A third aspect disclosed herein may be the fluid pump system according to the second aspect, in which the detector may be configured to detect the temperature of the bearing based on a temperature of cooling water used in the engine.

A fourth aspect disclosed herein may be the fluid pump system according to the second aspect, in which the detector may be configured to detect the temperature of the bearing based on a temperature of air introduced into the intake pipe.

A fifth aspect disclosed herein may be the fluid pump system according to any one of the second to fourth aspects, in which, when a cumulative operation time of the engine within a predetermined period is equal to or less than a predetermined time, the controller may be configured to output power that is lower than the designated power supply to the motor regardless of the temperature detected by the detector.

A sixth aspect disclosed herein may be the fluid pump system according to any one of the second to fourth aspects, in which, when a cumulative operation time of the fluid pump is equal to or greater than a predetermined time, the controller may be configured to output power that is lower than the designated power supply to the motor regardless of the temperature detected by the detector.

According to the first aspect, a load that is applied on the motor can be reduced when the temperature of the bearing is low and viscosity of lubricant is high. That is, the motor can be protected when it is more difficult for the output shaft to rotate by setting a rotary speed of the motor lower than its rotary speed in a normal state. Being configured to “output power that is lower than the designated power supply to the motor” includes not only cases of operating the motor at a lower speed than the rotary speed in the normal state, but also a case of not allowing the motor to rotate. Further, the detector may detect a value of a temperature sensor attached directly to the bearing, or may detect (estimate) a temperature of the bearing from a value of a temperature sensor attached to a portion other than the bearing (such as on a housing of the fluid pump). Further, the detector may detect (estimate) the temperature of the bearing from a value of a temperature sensor attached to a component other than the fluid pump.

According to the second aspect, the frequencies of maintenance and replacement of the evaporated fuel processing device necessitated by deterioration of the fluid pump can be reduced. That is, advantages of the fluid pump system disclosed herein can fully be exploited.

According to the third and fourth aspects, the temperature of the bearing can be detected by using an existing temperature sensor. That is, according to the third and fourth aspects, a new component (temperature sensor) for detecting the temperature of the bearing does not need to be added.

According to the fifth aspect, the controller supplies power at a normal level to the motor only when the engine has operated over a certain time within a certain period (predetermined period) (when there is an operation history within the certain period). By not allowing the fluid pump to operate in the normal state when there is no operation history within the certain period, it is further ensured that the deterioration of the fluid pump can be curtailed.

According to the sixth aspect, when a performance of the fluid pump has deteriorated (such as the motor being prone to becoming hot) due to the deterioration of the fluid pump (such as time-related deterioration), further deterioration of the motor can be curtailed by setting the rotary speed of the motor lower than its rotary speed in the normal state.

### BRIEF DESCRIPTION OF DRAWINGS

FIG. 1 shows a schematic diagram of an evaporated fuel processing device;

FIG. 2 shows a flowchart explaining an operation of a fluid pump system (first embodiment);

FIG. 3 shows a flowchart explaining an operation of a fluid pump system (second embodiment); and

FIG. 4 shows a flowchart explaining an operation of a fluid pump system (third embodiment).

### DETAILED DESCRIPTION

(Evaporated Fuel Processing Device)

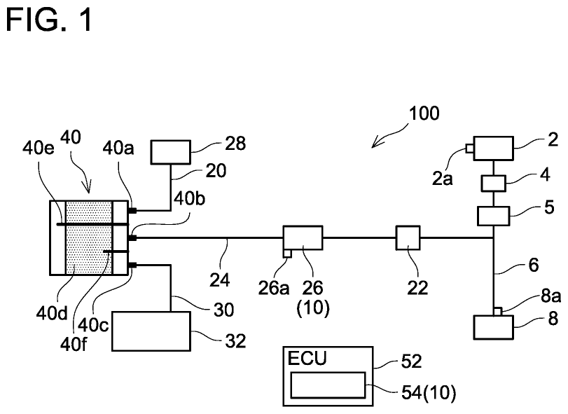

An evaporated fuel processing device 100 will be described with reference to FIG. 1. The evaporated fuel processing device 100 is mounted in a vehicle such as an automobile. The evaporated fuel processing device 100 is connected to an intake pipe 6 configured to supply air to an engine 2.

The intake pipe 6 is connected to the engine 2. The intake pipe 6 is a pipe for supplying the air to the engine 2. Further, a throttle valve 4, a supercharger 5, and an air cleaner 8 are provided on the intake pipe 6 in this order from the downstream side thereof (side closer to the engine 2). The throttle valve 4 is configured to control an amount of the air flowing into the engine 2. That is, the throttle valve 4 controls an air intake amount of the engine 2. The throttle valve 4 is controlled by an Engine Control Unit (ECU) 52. The supercharger 5 is configured to compress the air introduced into the intake pipe 6 and supply the same to the engine 2. The supercharger 5 is also controlled by the ECU 52. A temperature sensor 2a for detecting a temperature of cooling water is arranged in a vicinity of the engine 2. A detected value of the temperature sensor 2a is sent to the ECU 52.

The air cleaner 8 is connected to the intake pipe 6 upstream of the supercharger 5. The air cleaner 8 includes a filter configured to remove foreign particles from the air flowing into the intake pipe 6. When the throttle valve 4 opens, the air having passed through the air cleaner 8 flows through the intake pipe 6 and is suctioned into the engine 2. The engine 2 combusts fuel and the air therein, and discharges exhaust gas to an exhaust pipe (not shown) after the combustion. Further, a temperature sensor 8a is arranged in a vicinity of the air cleaner 8. The temperature sensor 8a is configured to detect a temperature of the air introduced into the intake pipe 6. A detected value of the temperature sensor 8a is sent to the ECU 52.

(Evaporated Fuel Processing Device)

The evaporated fuel processing device 100 is configured to supply evaporated fuel generated in a fuel tank 32 to the engine 2 through the intake pipe 6. The evaporated fuel processing device 100 is provided with a canister 40, a purge pipe 24, a pump 26, and a purge control valve 22. The pump 26 is an example of a fluid pump. The canister 40 includes activated carbon 40d therein, and is configured to adsorb the evaporated fuel generated in the fuel tank 32 by using the activated carbon 40d. The evaporated fuel generated in the fuel tank 32 is thereby prevented from being discharged into open air.

The canister 40 includes an air port 40a, a purge port 40b, and a tank port 40c. An air inlet pipe 20 is connected to the air port 40a. The air inlet pipe 20 connects the air port 40a to an air filter 28. A purge pipe 24 is connected to the purge port 40b. A vapor pipe 30 is connected to the tank port 40c. The vapor pipe 30 connects the tank port 40c to the fuel tank 32. When purge gas is to be supplied (purged) to the intake pipe 6, the air from outside is introduced into the canister 40 through the air inlet pipe 20, and the purge gas is supplied to the intake pipe 6 through the purge pipe 24. The air inlet pipe 20 may be regarded as being a part of the purge pipe 24. That is, a passage from an end of the air inlet pipe 20 (on an air filter 28 side) to an end of the purge pipe 24 (on an intake pipe 6 side) may be regarded as a purge passage.

As aforementioned, the activated carbon 40d is housed inside the canister 40. The ports 40a, 40b, and 40c are on one of wall surfaces of the canister 40 facing the activated carbon 40d. A space is provided between an inner wall of the canister 40 on the side where the ports 40a to 40c are provided and the activated carbon 40d. Further, a first partition plate 40e and a second partition plate 40f are fixed to the inner wall of the canister 40 on the side where the ports 40a to 40c are provided. The first partition plate 40e is located between the air port 40a and the purge port 40b and separates the space between the activated carbon 40d and the canister 40 into a space on an air port 40a side and a space on a purge port 40b side. The first partition plate 40e extends to a space on an opposite side from the side where the ports 40a to 40c are provided. The second partition plate 40f is located between the purge port 40b and the tank port 40c and separates the space between the activated carbon 40d and the canister 40 into the space on the purge port 40b side and a space on a tank port 40c side.

The activated carbon 40d is configured to adsorb the evaporated fuel from gas flowing into the canister 40 from the fuel tank 32 through the vapor pipe 30. The gas from which the evaporated fuel has been removed passes through the air inlet pipe 20 and the air filter 28 and is discharged to the open air. The canister 40 can prevent the evaporated fuel in the fuel tank 32 from being discharged into the open air. The evaporated fuel adsorbed by the activated carbon 40d is supplied to the purge pipe 24 as purge gas together with the air introduced from the air inlet pipe 20.

The first partition plate 40e separates the space where the air port 40a is connected and the space where the purge port 40b is connected. Due to this, the activated carbon 40d is ensured to be present on a passage between the ports 40a, 40b. The first partition plate 40e prevents the gas containing the evaporated fuel from being discharged into the open air and also prevents gas (air) introduced from the air port 40a from flowing directly from the purge port 40b to the purge pipe 24. The second partition plate 40f separates the space where the purge port 40b is connected and the space where the tank port 40c is connected. The second partition plate 40f prevents the gas (evaporated fuel) flowing from the tank port 40c into the canister 40 from flowing directly to the purge pipe 24. By providing the first partition plate 40e and the second partition plate 40f, mixed gas of the evaporated fuel adsorbed by the activated carbon 40d and the air introduced from the air inlet pipe 20 is supplied to the purge pipe 24 as the purge gas.

The purge pipe 24 configures a passage (purge passage) for supplying the evaporated fuel adsorbed by the canister 40 to the intake pipe 6 as the purge gas. The purge pipe 24 connects the canister 40 to the intake pipe 6. Specifically, the purge pipe 24 is connected to the intake pipe 6 at a position between the supercharger 5 and the air cleaner 8 and upstream of the supercharger 5. The mixed gas (purge gas) of the air supplied to the canister 40 through the air inlet pipe 20 and the evaporated fuel adsorbed by the canister 40 flows in the purge pipe 24. A flexible material such as rubber and resin, or a metal material such as iron may be used as a material of the purge pipe 24.

The purge control valve 22 is arranged on the purge pipe 24 downstream of the canister 40. When the purge control valve 22 is closed, supply of the purge gas is stopped by the purge control valve 22. When the purge control valve 22 is opened and the pump 26 is operated, the purge gas is supplied into the intake pipe 6. The purge control valve 22 is an electronic valve, and is controlled by the ECU 52. Specifically, the purge control valve 22 is duty-controlled by a signal outputted from the ECU 52. That is, the ECU 52 is configured to adjust an opening time of the purge control valve 22 by adjusting a duty cycle of the outputted signal. The ECU 52 also performs duty-control on the throttle valve 4 as it does on the purge control valve 22 and adjusts its aperture (opening time).

The pump 26 is arranged on the purge pipe 24 between the canister 40 and the purge control valve 22. A well-known pump such as a so-called vortex pump (which may also be called cascade pump or Wesco pump) or a centrifugal pump is used as the pump 26. Although description on a specific structure of the pump 26 will be omitted, the pump 26 includes a motor, a bearing that supports an output shaft of the motor, and an impeller attached to the output shaft of the motor.

The pump 26 is controlled by a pump controller 54 in the ECU 52. Due to this, the fluid pump system 10 may be said as being configured of the pump 26 and the pump controller 54. A temperature sensor 26a is attached to the pump 26. Specifically, the temperature sensor 26a is attached to a casing of the pump 26. The temperature sensor 26a is configured to detect a temperature of the pump 26. A detected value of the temperature sensor 26a is sent to the ECU 52. A filter for removing foreign particles may be provided at a discharge outlet of the pump 26, although the configuration is not particularly limited thereto.

The pump controller 54 is a part of the ECU 52 and is integrally configured with the other parts of the ECU 52 (such as a part configured to control the engine 2). The pump controller 54 is an example of a controller. The pump controller 54 may be separated from the ECU 52. The pump controller 54 includes a CPU and a memory such as a ROM and a RAM. When the ECU 52 determines that the purge gas needs to be supplied to the engine 2, the pump controller 54 supplies power for operating the pump 26 based on an instructed value (pump rotary speed) from the ECU 52.

Although the details will be described later, the pump controller 54 is configured to estimate a temperature of the bearing supporting the output shaft of the motor (hereinbelow termed shaft bearing) by referring to a table stored in the memory based on the detected value of the temperature sensor 26a. When determining that the temperature of the shaft bearing is lower than a predetermined temperature, the pump controller 54 outputs power that is lower than a designated power supply to the motor of the pump 26 so that the pump 26 operates at a speed lower than the instructed value from the ECU 52 (including zero speed).

Here, a variant of the fluid pump system 10 will be described. As aforementioned, the pump controller 54 estimates the temperature of the shaft bearing based on the detected value of the temperature sensor 26a attached to the casing of the pump 26. However, the temperature sensor 26a may be attached to the shaft bearing and the temperature of the shaft bearing may be measured directly. In this case, the temperature of the shaft bearing can be obtained more accurately, and a program (temperature estimation program) to be stored in the memory of the pump controller 54 may be omitted.

Further, the pump controller 54 may estimate the temperature of the shaft bearing based on the detected value of the temperature sensor 2a for detecting the temperature of the cooling water of the engine 2. Alternatively, the pump controller 54 may estimate the temperature of the shaft bearing based on the detected value of the temperature sensor 8a for detecting the temperature of the air introduced into the intake pipe 6. In all of the above cases, the temperature sensor 26a attached to the pump 26 can be omitted. The temperature sensors 2a, 8a are attached to vehicles in general without exception. Due to this, by estimating the temperature of the shaft bearing based on the detected value of the temperature sensor 2a or 8a, the temperature of the shaft bearing can be detected without adding a new component (temperature sensor 26a).

(Operation of Fluid Pump System: First Embodiment)

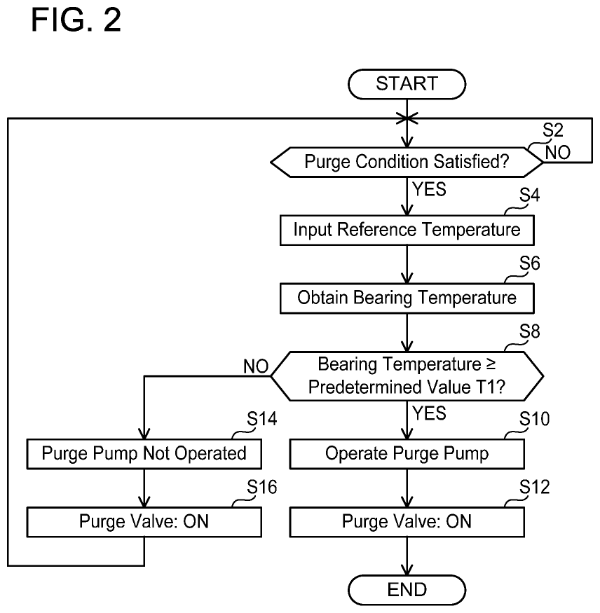

An operation of the fluid pump system 10 will be described with reference to FIG. 2. In the following description, an example of estimating the temperature of the shaft bearing based on the detected value of the temperature sensor 26a will be described, however, as aforementioned, the temperature of the shaft bearing may be estimated based on the detected value of the temperature sensor 2a or 8a, or the temperature of the shaft bearing may be measured directly.

Firstly, the pump controller 54 determines whether a purge condition is satisfied, that is, whether an instruction to operate the pump 26 has been sent from the ECU 52 (step S2). In the case where the purge condition is not satisfied (step S2: NO), the pump controller 54 repeats this determination of step S2. In the case where the purge condition is satisfied (step S2: YES), the pump controller 54 inputs the detected value of the temperature sensor 26a as a reference temperature (step S4). Then, the pump controller 54 obtains the temperature of the shaft bearing based on the table, which is stored in the memory, indicating a relationship between the detected value of the temperature sensor 26a and the temperature of the shaft bearing (step S6).

Next, the pump controller 54 compares the temperature of the shaft bearing and a predetermined value T1 (step S8). The predetermined value T1 is set to a temperature at which viscosity of lubricant (grease) used in the shaft bearing becomes sufficiently high. In the case where the temperature of the shaft bearing (estimated value) is equal to or greater than the predetermined value T1 (step S8: YES), the pump controller 54 supplies the power to the pump 26 and operates the pump 26 so that the shaft rotates at the rotary speed designated by the ECU 52 (step S10). After this, the purge gas is supplied from the canister 40 to the intake pipe 6 by opening the purge control valve 22 (step S12).

In the case where the temperature of the shaft bearing is less than the predetermined value T1 (step S8: NO), the pump controller 54 does not supply the power to the pump 26. As a result, the pump 26 does not operate (step S14). However, even when the pump 26 does not operate, the purge control valve 22 is opened (step S16). By opening the purge control valve 22, the canister 40 and the intake pipe 6 communicates with each other. The purge gas is supplied (suctioned) into the intake pipe 6 by a negative pressure generated in the intake pipe 6.

According to steps S14, S16, since the pump 26 is not operated, the purge gas is supplied to the intake pipe 6 at an amount that is less than an amount of a purge gas supply set by the ECU 52. However, an air-fuel ratio of the fuel supplied to the engine 2 is controlled by feedback. Due to this, the ECU 52 adjusts a fuel supply amount from the fuel tank 32 to compensate for this decrease in the purge gas supply amount from its set value and thereby adjusts the air-fuel ratio. That is, even when the pump 26 is not operated (step S14) despite the purge condition having been satisfied (step S2), the air-fuel ratio of the fuel supplied to the engine 2 is prevented from deviating from its set value.

By not supplying the power to the pump 26 in the case where the temperature of the shaft bearing is less than the predetermined value T1, the pump 26 can be prevented from being operated when the viscosity of the lubricant used in the shaft bearing is high. A load applied to the pump 26 can be reduced, thereby deterioration of the pump 26 can be curtailed.

### Second Embodiment

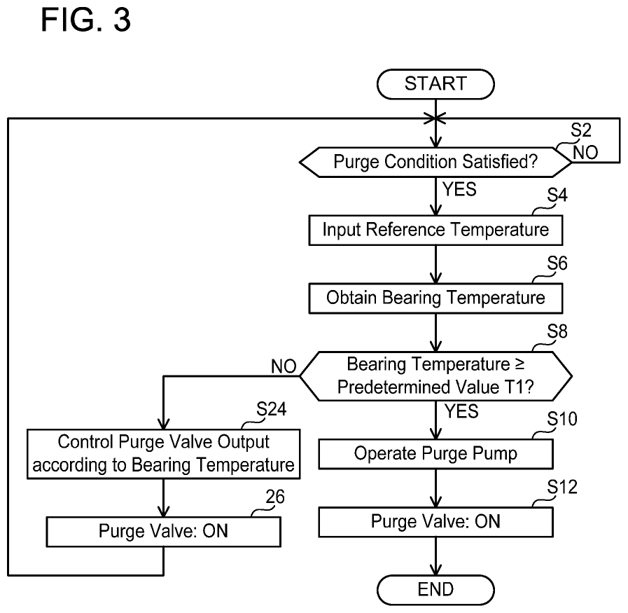

A variant of the operation of the fluid pump system 10 will be described with reference to FIG. 3. Operations of steps S2 to S12 shown in FIG. 3 are the same as steps S2 to S12 explained in the first embodiment (FIG. 2). Due to this, in the present embodiment, explanation on the operations of steps S2 to S12 will be omitted.

In the present embodiment, in the case where the temperature of the shaft bearing is less than the predetermined value T1 (step S8: NO), the pump controller 54 controls output of the pump 26 in accordance with the temperature of the shaft bearing (step S24). That is, even when the temperature of the shaft bearing is less than the predetermined value T1, the pump 26 is not completely stopped and is operated at a speed lower than the instructed value from the ECU 52. After this, by opening the purge control valve 22, the purge gas is supplied from the canister 40 to the intake pipe 6 (step S26). The speed to operate the pump 26 is controlled by the power outputted to the pump 26.

In the present embodiment, by operating the pump 26 even when the temperature of the shaft bearing is less than the predetermined value T1, the evaporated fuel that is collected in the canister 40 can be prevented from exceeding a capacity of the canister 40. In other words, the canister 40 can be downsized. In the present embodiment as well, since the pump 26 is operated at a speed lower than the instructed value from the ECU 52 in the case where the temperature of the shaft bearing is less than the predetermined value T1, the load applied to the pump 26 can be reduced, and the deterioration of the pump 26 can be curtailed.

### Third Embodiment

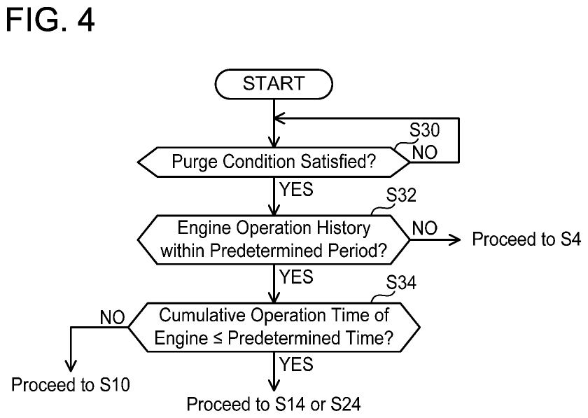

Another variant of the fluid pump system 10 will be described with reference to FIG. 4. In the present embodiment, firstly the pump controller 54 determines whether the purge condition is satisfied (step S30), and repeats this determination of step S30 in the case where the purge condition is not satisfied (step S30: NO). In the case where the purge condition is satisfied (step S30: YES), the pump controller 54 determines whether there is an operation history of the engine 2 within a predetermined period in the past from when the purge condition was satisfied. In the case where the engine 2 was not operated within the predetermined period (step S32: NO), the pump controller 54 proceeds to step S4 of the first embodiment (FIG. 2) or the second embodiment (FIG. 3) and proceeds with the processes described in the corresponding embodiment.

On the other hand, in the case where the engine 2 was operated within the predetermined period (step S32: YES), the pump controller 54 determines whether a cumulative operation time of the engine 2 within the predetermined period is equal to or less than a predetermined time (step S34). That is, in step S32, the pump controller 54 determines whether the engine 2 was operated for a large amount of time (exceeding the predetermined time) within the predetermined period in the past from when the purge condition was satisfied.

In the case where the cumulative operation time of the engine 2 is equal to or less than the predetermined time (step S34: YES), the pump controller 54 proceeds to step S14 in FIG. 2 and does not operate the pump 26 (step S14), or proceeds to step S24 in FIG. 3 and controls the output of the pump 26 according to the temperature of the shaft bearing (step S24). On the other hand, in the case where the cumulative operation time of the engine 2 exceeds the predetermined time (step S34: NO), the pump controller 54 proceeds to step S10 in FIG. 2 or 3, and supplies the power to the pump 26 and operates the pump 26 so that the shaft rotates at the rotary speed designated by the ECU 52.

In the present embodiment, the same processes as those of the first embodiment (FIG. 2) or the second embodiment (FIG. 3) are executed in the case where the engine 2 was not operated within the predetermined period. However, in the case where the engine 2 was operated within the predetermined period, the pump 26 is controlled (stopped or operated at low speed) in accordance with the cumulative operation time of the engine 2 regardless of the temperature of the shaft bearing. When the engine 2 operates, the temperature of the surroundings of the engine 2 rises. Due to this, when the engine 2 operates, the temperature of the shaft bearing rises and the viscosity of the lubricant used in the shaft bearing decreases. In the present embodiment, since the pump 26 is operated at the normal level only in the case where the cumulative operation time of the engine 2 within the predetermined period exceeds the predetermined time, it is ensured that the load applied to the pump 26 can further be reduced.

### Other Embodiments

In the embodiments above, examples using the fluid pump system for pumping the purge gas in the evaporated fuel processing device have been described. However, the fluid pump system disclosed herein may be used for purposes other than pumping the purge gas. That is, the fluid pump system disclosed herein may be employed in devices other than the evaporated fuel processing device. What is important herein is to reduce the load applied to the motor by detecting the temperature of the shaft bearing (by measurement or estimation), supplying the motor with the power that is lower than the power supply designated for the motor when the temperature of the shaft bearing is less than the predetermined temperature, and decreasing operation torque of the motor. Due to this, the method of estimating the temperature of the shaft bearing may for example be a method other than those described in the above embodiments.

Further, a cumulative operation time of the fluid pump may be stored, and the predetermined value T1 as above may be corrected in accordance with this cumulative operation time. For example, when the cumulative operation time of the fluid pump is long and deterioration of the fluid pump is in progress, the predetermined value T1 may be corrected to be higher and the condition for operating the fluid pump at the normal level (temperature of the shaft bearing) may be made stricter. That is, when the cumulative operation time of the fluid pump is equal to or greater than the predetermined time, the controller may output the power that is lower than the designated power supply to the motor regardless of the temperature detected by the detector.

Specific examples of the present invention have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

What is claimed is:

1. A fluid pump system comprising:
a fluid pump including a motor, a bearing supporting an output shaft of the motor, and an impeller attached to the output shaft;
a detector configured to detect a temperature of the bearing; and
a controller configured to control an output of the motor,
wherein
the controller is configured to output power that is lower than a designated power supply to the motor when the temperature detected by the detector is lower than a predetermined temperature.

2. The fluid pump system according to claim 1, wherein
the fluid pump system is used in an evaporated fuel processing device configured to supply evaporated fuel generated in a fuel tank to an intake pipe connected to an engine,
the evaporated fuel processing device comprises:
a canister configured to adsorb the evaporated fuel generated in the fuel tank;
a purge pipe connecting the canister to the intake pipe; and
a purge control valve configured to switch between a state where the canister communicates with the intake pipe and a state where the canister is cut off from the intake pipe, and
the fluid pump is arranged upstream of the purge control valve and configured to pump purge gas from the canister to the intake pipe.

3. The fluid pump system according to claim 2, wherein
the detector is configured to detect the temperature of the bearing based on a temperature of cooling water used in the engine.

4. The fluid pump system according to claim 2, wherein
the detector is configured to detect the temperature of the bearing based on a temperature of air introduced into the intake pipe.

5. The fluid pump system according to claim 2, wherein
when a cumulative operation time of the engine within a predetermined period is equal to or less than a predetermined time, the controller is configured to output power that is lower than the designated power supply to the motor regardless of the temperature detected by the detector.

6. The fluid pump system according to claim 2, wherein
when a cumulative operation time of the fluid pump is equal to or greater than a predetermined time, the controller is configured to output power that is lower than the designated power supply to the motor regardless of the temperature detected by the detector.

7. The fluid pump system according to claim 3, wherein
when a cumulative operation time of the engine within a predetermined period is equal to or less than a predetermined time, the controller is configured to output power that is lower than the designated power supply to the motor regardless of the temperature detected by the detector.

8. The fluid pump system according to claim 3, wherein
when a cumulative operation time of the fluid pump is equal to or greater than a predetermined time, the controller is configured to output power that is lower than the designated power supply to the motor regardless of the temperature detected by the detector.

9. The fluid pump system according to claim 4, wherein
when a cumulative operation time of the engine within a predetermined period is equal to or less than a predetermined time, the controller is configured to output power that is lower than the designated power supply to the motor regardless of the temperature detected by the detector.

10. The fluid pump system according to claim 4, wherein
when a cumulative operation time of the fluid pump is equal to or greater than a predetermined time, the controller is configured to output power that is lower than the designated power supply to the motor regardless of the temperature detected by the detector.
